(19) United States
(12) Patent Application Publication
(10) Pub. No.: US 2009/0314550 A1
(43) Pub. Date: Dec. 24, 2009

(54) Touchpad designed in a planar configuration that can be molded to conform to a non-planar object

(76) Inventor: Michael D. Layton, Salt Lake City, UT (US)

Correspondence Address: MORRISS OBRYANT COMPAGNI, P.C., 734 EAST 200 SOUTH, SALT LAKE CITY, UT, 84102, US

(21) Appl. No.: 12/214,438

(22) Filed: Jun. 18, 2008

(51) Int. Cl. G06F 3/041

(52) U.S. Cl. 178/18.03

(57) ABSTRACT

A capacitance sensitive touchpad that is formed as a plurality of electrodes disposed on a flat substrate, wherein spaces are created between electrodes, wherein the spaces between the electrodes can then be cut from the substrate, and wherein the remaining edges of the substrate can then be brought closer together to thereby form a three dimensional shape and yet still provide desired touchpad functionality.

### BACKGROUND OF THE INVENTION

1. Field of the Invention

This invention relates generally to touchpad technology. More specifically, the present invention relates to creating a touchpad electrode layout design that can be manufactured as a flat or planar sheet, cut from the flat sheet, and then bent and folded so that curved to form a non-planar shape such as a sphere.

2. Description of Related Art

Touchpad technology was developed as a planar technology on a rigid substrate material such as printed circuit board (PCB), enabling a user to slide a finger or other conductive object over a flat surface, and thereby perform common touchpad functions such as cursor control and scrolling.

Later, the substrate used in touchpads was modified by using a flexible substrate material. Use of a flexible substrate enabled a final electrode design to be curved against an appropriate arcuate surface, thereby enabling a touchpad to be used where a surface had a slight curvature, as long as the curvature did not affect too greatly the operation of the touchpad algorithms used to detect and track the position of an object on or near the surface of the arcuate touchpad. However, even in this case, the curvature was not spherical in nature. In other words, the flexible substrate material could be curved around a cylinder, but not around a sphere.

It is now desirable to use touchpads in applications or environments where touchpads have not been used before, but would be beneficial because of the advantages that are inherent to touchpad design. Accordingly, it would be an advantage over previous touchpad designs to provide a touchpad can designed and manufactured as a flat arrangement of electrodes, but then formed or molded around a non-planar object.

It should be recognized that the curved surfaces being considered are not curved surfaces that can be flattened without distortion. For example, a cylinder or cone have a curved surface, but can be flattened to form a planar object without distortion. Instead, the present invention involves those surfaces that cannot be flattened without creating distortion. Such surfaces are those of a sphere or parabolic dish. Placing a flat material on such surfaces can only be done by distorting or stretching the flat material. Thus it would be an advantage over the prior art to provide a system and method for taking a planar substrate material and modifying it such that it can be disposed over a curved surface such as a sphere or parabolic dish shape without having to strength the substrate material.

An important aspect of the present invention is the use of existing capacitance sensing technology that can compensate for variations in the design of electrodes and electrode layout. Touchpad technology by CIRQUE® Corporation has been adapted to perform this function. Accordingly, it is useful to understand at least one embodiment of this touchpad technology. However, it should be remembered that other touchpad technology can also be modified to provide the function of the present invention.

The CIRQUE® Corporation touchpad is a mutual capacitance-sensing device and an example is illustrated in FIG. 1. In this touchpad, a grid of row and column electrodes is used to define the touch-sensitive area of the touchpad. Typically, the touchpad is a rectangular grid of approximately 16 by 12 electrodes, or 8 by 6 electrodes when there are space constraints. Interlaced or otherwise disposed within or around these row and column electrodes is a single sense electrode. All position measurements are made through the sense electrode.

In more detail, FIG. 1 shows a capacitance sensitive touchpad 10 as taught by CIRQUE® Corporation includes a grid of row (12) and column (14) (or X and Y) electrodes in a touchpad electrode grid. All measurements of touchpad parameters are taken from a single sense electrode 16 also disposed on the touchpad electrode grid, and not from the X or Y electrodes 12, 14. No fixed reference point is used for measurements. A touchpad sensor circuit 20 generates signals from P,N generators 22, 24 that are sent directly to the X and Y electrodes 12, 14 in various patterns. Accordingly, there is a one-to-one correspondence between the number of electrodes on the touchpad electrode grid, and the number of drive pins on the touch sensor circuitry 20.

The touchpad 10 does not depend upon an absolute capacitive measurement to determine the location of a finger (or other capacitive object) on or in proximity to the touchpad surface. Hereinafter it should be assumed that the touchpad of the present invention is capable of touch and/or proximity sensing whenever contact is being described with the touchpad.

The touchpad 10 measures an imbalance in electrical charge to the sense line 16. When no pointing object is on the touchpad 10, the touch sensor circuitry 20 is in a balanced state, and there is no signal on the sense line 16. There may or may not be a capacitive charge on the electrodes 12, 14. In the methodology of CIRQUE® Corporation, that is irrelevant. When a pointing device creates imbalance because of capacitive coupling, a change in capacitance occurs on the plurality of electrodes 12, 14 that comprise the touchpad electrode grid. What is measured is the change in capacitance, and not the absolute capacitance value on the electrodes 12, 14. The touchpad 10 determines the change in capacitance by measuring the amount of charge that must be injected onto the sense line 16 to reestablish or regain balance on the sense line.

The touchpad 10 must make two complete measurement cycles for the X electrodes 12 and for the Y electrodes 14 (four complete measurements) in order to determine the position of a pointing object such as a finger. The steps are as follows for both the X 12 and the Y 14 electrodes:

First, a group of electrodes (say a select group of the X electrodes 12) are driven with a first signal from P, N generator 22 and a first measurement using mutual capacitance measurement device 26 is taken to determine the location of the largest signal. However, it is not possible from this one measurement to know whether the finger is on one side or the other of the closest electrode to the largest signal.

Next, shifting by one electrode to one side of the closest electrode, the group of electrodes is again driven with a signal. In other words, the electrode immediately to the one side of the group is added, while the electrode on the opposite side of the original group is no longer driven.

Third, the new group of electrodes is driven and a second measurement is taken.

Finally, using an equation that compares the magnitude of the two signals measured, the location of the finger is determined with a high degree of precision.

Accordingly, the touchpad 10 measures a change in capacitance in order to determine the location of a finger. All of this hardware and the methodology described above assume that the touch sensor circuit 20 is directly driving the electrodes 12, 14 of the touchpad 10. Thus, for a typical 12×16 electrode grid touchpad, there are a total of 28 pins (12+16=28) available from the touch sensor circuitry 20 that are used to drive the electrodes 12, 14 of the electrode grid.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes on the same rows and columns, and other factors that are not material to the present invention.

Although the CIRQUE® touchpad described above uses a grid of X and Y electrodes and a separate and single sense electrode, the sense electrode can also be the X or Y electrodes by using multiplexing. Either design will enable the present invention to function.

### BRIEF SUMMARY OF THE INVENTION

In a preferred embodiment, the present invention is a capacitance sensitive touchpad that is formed as a plurality of electrodes disposed on a flat substrate, wherein spaces are created between electrodes, wherein the spaces between the electrodes can then be cut from the substrate or simply folded underneath so as not to interfere, and wherein the remaining edges of the substrate can then be brought closer together and thereby form a three dimensional shape and yet still provide standard touchpad functionality.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective diagram of the components of a single capacitance-sensitive touchpad.

FIG. 2 is a perspective view of a globe that is wrapped in a sinusoidal projection of the earth.

FIG. 3 is the sinusoidal projection of the earth that is now laid flat to demonstrate that a three dimensional object can first be created on a flat surface.

FIG. 4 is a sinusoidal projection having a larger number of lobes than shown in the sinusoidal projection of FIGS. 2 and 3.

FIG. 5 is provided as a top perspective view of a substrate that will be folded to form a cube.

FIG. 6 is a perspective view of the touchpad substrate of FIG. 5, wherein the remaining touchpad substrate is folded along lines to create a cube.

FIG. 7 is a top elevational view of a flat substrate material before it is cut to firm the cube of FIG. 6.

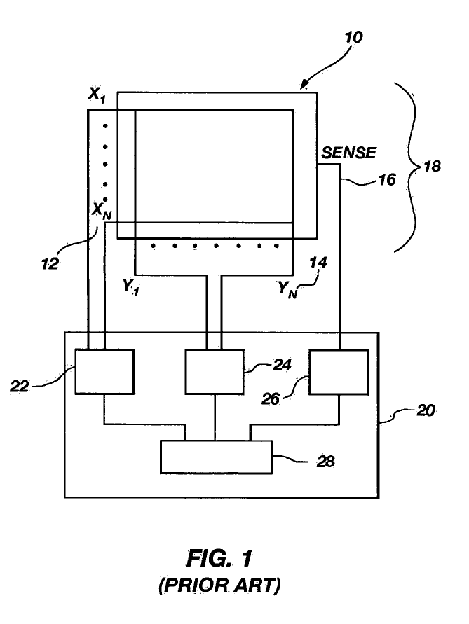

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The present invention is a system and method for construction a touchpad that must be folded so that it can be used. The present invention is a flat substrate having a plurality of electrodes disposed thereon, and which only becomes functional if portions of the substrate that do not contain electrodes are removed, and then the remaining portions of the substrate are at least partially folded to form a three dimensional object.

A good analogy for the present invention is to consider a flat map of the earth. A flat map of the earth distorts the true size of the land masses that are away from the equator. Thus, cartographers created new maps that try to preserve the true dimensions of all areas of the earth, regardless of their proximity to the equator. However, there is more than one way to take a three dimensional object and cut it so that it can lay out on a flat surface. Likewise, the examples that follow should not be considered to be limiting but are only an illustration of an important aspect of the present invention.

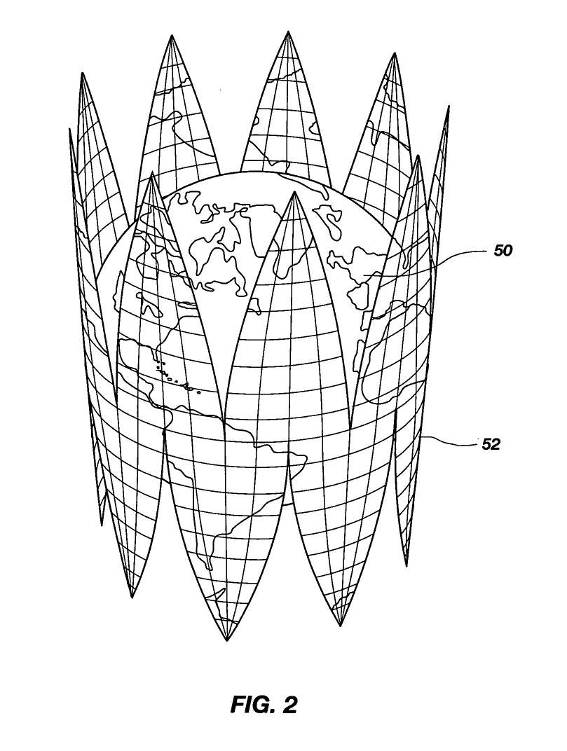

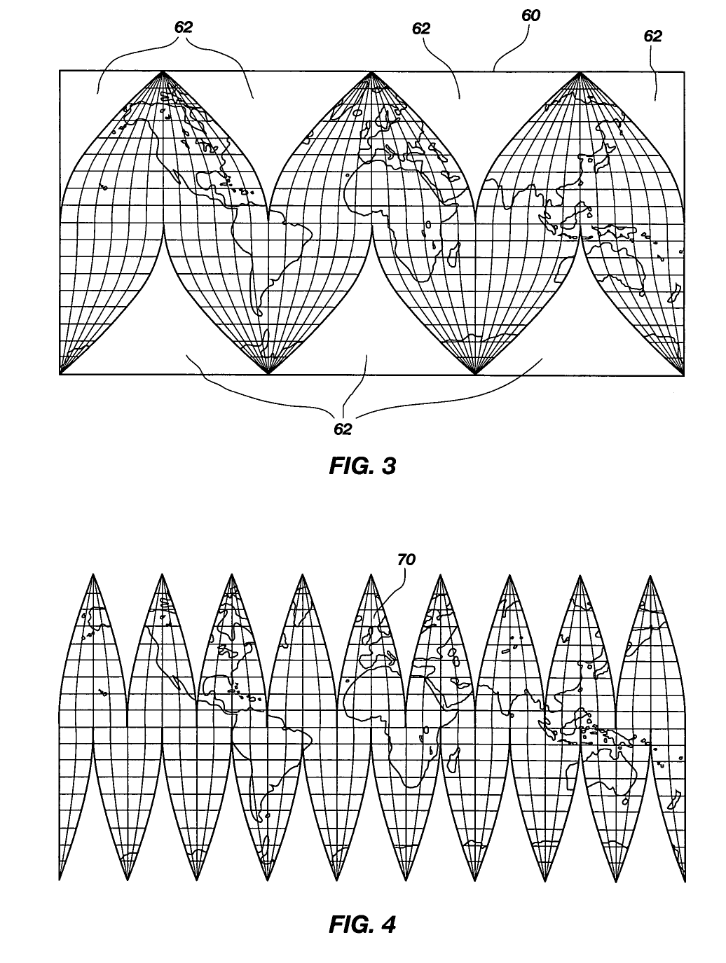

FIG. 2 is provided as a perspective view of a sphere 50 (the globe of the earth), with a sinusoidal map 52 disposed around the sphere. The sinusoidal map 52 can be laid flat, as show in FIG. 3.

In FIG. 3, a rectangular piece of material 60 represents the material from which the substrate of the present invention will be cut. Superimposed over that rectangular piece of material 60 is also shown the sinusoidal map of the earth 52 from FIG. 2. After disposing a desired pattern of electrodes on the rectangular piece of material 60, the portions 62 of the rectangular piece of material 60 that do not contain electrodes will be cut out and removed. The remainder of the rectangular piece of material 60 is the substrate 52 that is then folded to form the three dimensional spherical touchpad. To complete construction of the spherical touchpad, the sides of the substrate 50 are brought together as well as the top and bottom ends of the substrate would be folded together as if the substrate were being folded to form a spherical globe 50. The result is a spherical touchpad.

It is important to understand that when creating a spherical touchpad, the number of lobes shown in the example of FIGS. 2 and 3 was arbitrarily selected. The number of lobes can be increased or even decreased. A substrate 70 formed from a greater number of lobes is shown in FIG. 4.

An alternative embodiment includes the concept of not having to cut away portions of the flat substrate. The portions that are not needed might simply be folded so as not to interfere with the remaining portions of the substrate that are then used form the three dimensional touchpad. Hence, the unneeded portions can be folded underneath. Alternatively, a single cut might be made, and then the unneeded portion might again be folded underneath like a flap.

When approximating a three dimensional surface with planar surface elements, there may be distortion because a flat substrate will not perfectly conform to the surface of a three dimensional surface. The problem is worse when the three dimensional surface includes a spherical object. The maximum distortion is limited by the curvature of the desired surface and the width of the elements or lobes that are formed into the shape of a sphere (in addition to shape, projection method, etc.). When the lobes are large compared to the resulting spherical surface, the distortion is also large. By reducing the width of the lobes, the distortion may be made smaller. In this respect, narrow electrode strips which are approximately linear in shape may be ideal since their narrow widths allow maximum conformity to the 3D surface.

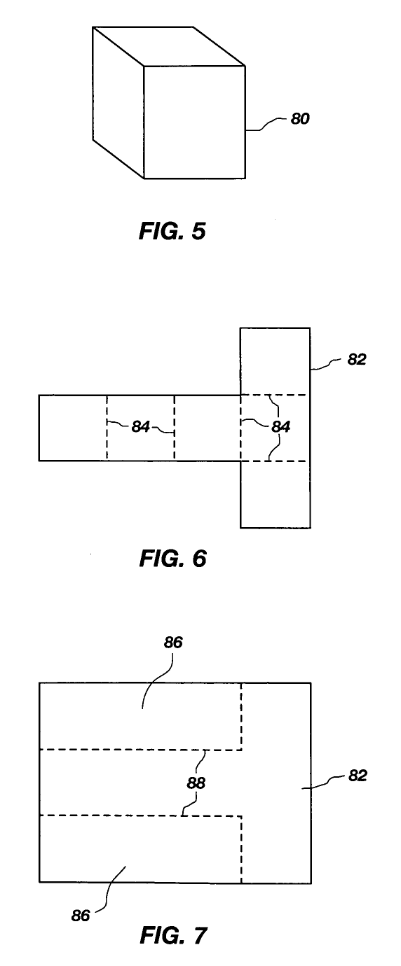

The present invention should also not be considered to be limited to forming a spherical three dimensional shape such as a globe. The final touchpad substrate shape can be any three dimensional shape. For example, consider a cube 80 as shown in FIG. 5.

FIG. 6 is provided as a top elevational view of a substrate 82 that can be folded along dotted lines 84 to form the cube 80. Thus, the substrate 62 is first laid out as a flat substrate material as shown in FIG. 6.

The substrate 82 of FIG. 6 is cut from a rectangular piece of substrate material as shown in FIG. 7, where portions 86 are then cut or otherwise removed from the substrate 82 along dotted lines 88. The resulting substrate 82 is then folded along the dotted lines 84 shown in FIG. 6. The resulting cube 80 is shown in a perspective view in FIG. 5.

Many three dimensional shapes that can first be laid out on a flat surface can be folded or molded to form a desired three dimensional shape. Any three dimensional shape that can be created from a flat piece of substrate material should therefore be considered to be within the scope of the present invention.

In another alternative embodiment, consider an outer touchpad and an inner touchpad forming a spherical touchpad. Using the earth map analogy, the outer touchpad could provide electrodes that are essentially the longitude lines, and an inner touchpad could provide the electrodes that are the latitude lines. The inner touchpad can be laminated to the inside surface of the outer touchpad. The inner touchpad could be a single electrode centered on the “equator” of the spherical touchpad.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for creating a three dimensional touchpad, said method comprising the steps of:
1) providing a flat substrate material;
2) disposing a plurality of electrodes on the flat substrate material, wherein the pattern of electrodes is formed on only a first portion of the flat substrate material;
3) removing a second portion of the flat substrate material that does not contain any of the plurality of electrodes; and
4) folding the first portion of the flat substrate material to form a desired three dimensional touchpad shape.

2. The method as defined in claim 1 wherein the method further comprises the step of disposing the pattern of electrodes on the flat substrate material to create a plurality of lobes that form the first portion.

3. The method as defined in claim 2 wherein the method further comprises the step of folding the first portion of the flat substrate material to form a substantially spherical touchpad.

4. The method as defined in claim 2 wherein the method further comprises the step of making the plurality of lobes narrow to thereby reduce distortion of the three dimensional touchpad shape.

5. A method for creating a three dimensional touchpad, said method comprising the steps of:
1) providing a flat substrate material;
2) disposing a plurality of electrodes on the flat substrate material, wherein the pattern of electrodes is formed on only a first portion of the flat substrate material;
3) making at least one cut in the flat substrate material such that the flat substrate material can be folded; and
4) folding the first portion of the flat substrate material to form a desired three dimensional touchpad shape without having to remove any of the flat substrate material.

6. A method for creating a three dimensional touchpad, said method comprising the steps of:
1) providing a flat substrate material;
2) disposing a plurality of electrodes on the flat substrate material, wherein the pattern of electrodes is formed on only a first portion of the flat substrate material; and
3) folding the flat substrate material to form a desired three dimensional touchpad shape.

7. The method as defined in claim 6 wherein the method further comprises the step of folding a second portion of the flat substrate material that does not contain the plurality of electrodes underneath the first portion so that the second portion is hidden by the first portion.

8. The method as defined in claim 6 wherein the method further comprises the step of removing a second portion of the flat substrate material that does not contain any of the plurality of electrodes.

9. The method as defined in claim 6 wherein the method further comprises the step of making at least one cut in the flat substrate material such that the flat substrate material can be folded.
